(19) United States
(12) Patent Application Publication
(10) Pub. No.: US 2009/0136806 A1
(43) Pub. Date: May 28, 2009

(54) Tube Shaped Fuel Cell Module and Manufacturing Method thereof

(76) Inventors: Masahiro Imanishi, Shizuoka-ken (JP); Haruyukl Nakanishi, Shizuoka-ken (JP); Shigeaki Murata, Shizuoka-ken (JP); Yoshihisa Tamura, Shizuoka-ken (JP)

Correspondence Address: KENYON & KENYON LLP, 1500 K STREET N.W., SUITE 700, WASHINGTON, DC, 20005, US

(21) Appl. No.: 12/084,140

(22) PCT Filed: Nov. 9, 2006
(86) PCT No.: PCT/IB2006/003163

§ 371 Date: Apr. 25, 2008

(30) Foreign Application Priority Data
Nov. 10, 2005 (JP) 2005-326654

(51) Int. Cl. H01M 8/10; B32B 37/00

(52) U.S. Cl. 429/26; 156/219; 429/31

(57) ABSTRACT

A tube shaped fuel cell module which includes a plurality of tube shaped fuel cell cells each of which has, in order from the inside, an internal collector, an inside catalyst electrode layer, a solid electrolyte membrane and an outside catalyst electrode layer; and an external collector which collects power from the tube shaped fuel cell cells, is such that the external collector has a corrugated plate structure in which convex portions and concave portions continuously alternate. The tube shaped fuel cell module is also provided with at least one cell-collector unit which includes the external collector, and the plurality of tube shaped fuel cell cells which contact the surface of the concave portions of the external collector along the entire lengths of the tube shaped fuel cell cells.

### BACKGROUND OF THE INVENTION

1. Field of the Invention

The invention relates to a tube shaped fuel cell module having excellent power collecting efficiency and a manufacturing method of that tube shaped fuel cell module.

2. Description of the Related Art

A unit cell which is the smallest power generating unit of a solid polymer electrolyte fuel cell having a flat plate construction (hereinafter also simply referred to as “flat plate fuel cell”) has a membrane electrode assembly (MEA) in which a catalyst electrode layer is joined to both sides of a solid electrolyte membrane, a gas diffusion layer arranged on both sides of this membrane electrode assembly, and a separator arranged on the outside of the gas diffusion layer.

In order to reduce the size of the flat plate fuel cell and improve the power generating reaction area per unit volume, the solid electrolyte membrane and the like that form the flat plate fuel cell must be made thinner. However, in view of function and strength, each structural member can desirably be made only so thin and the design of this kind of thin flat plate fuel cell is reaching its limits. Therefore in recent years, tube shaped fuel cells have been developed in place of flat plate fuel cells.

A unit cell which is the smallest power generating unit of a tube shaped fuel cell (i.e., a tube shaped fuel cell cell) has a hollow membrane electrode assembly (MEA) that includes, for example, a hollow solid electrolyte membrane, an inside catalyst electrode layer arranged on the inside of the solid electrolyte membrane, and an outside catalyst electrode layer arranged on the outside of the solid electrolyte layer. Moreover, an internal collector is arranged on the inside of the inner catalyst electrode layer and an external collector is arranged on the outside of the outside catalyst electrode layer. That is, a typical tube shaped fuel cell cell has, in order from inside to outside, an internal collector, an inside catalyst electrode layer, a solid electrolyte membrane, an outside catalyst electrode layer, and an external collector.

In this kind of tube shaped fuel cell cell, electric energy is generated through an electrochemical reaction produced by supplying one of two reaction gases, either a gas containing oxygen or a gas containing hydrogen, to the hollow membrane electrode assembly, and supplying the other reaction gas to the outer portion of the hollow membrane electrode assembly. When a plurality of these tube shaped fuel cell cells are arranged to form a tube shaped fuel cell, the reaction gas supplied to the outer portion of each of the membrane electrode assemblies is the same so there is no longer any need for the separator that was provided in a conventional flat plate fuel cell, thereby enabling the fuel cell to effectively be made smaller.

However, in order to further improve the power generating performance of the tube shaped fuel cell, it is necessary to improve the efficiency when extracting the electric energy generated in each tube shaped fuel cell cell (i.e., the power collecting efficiency). This power collecting efficiency can be improved by, for example, bringing a collecting member into contact with the plurality of tube shaped fuel cell cells.

In the past, various technologies have been described which are aimed at improving the power collecting efficiency of tube shaped fuel cells. For example, Japanese Patent Application Publication No. JP-A-2004-288542 describes technology relating to a fuel cell system provided with a cell assembly formed by a plurality of tube shaped fuel cell cells connected together via a cell connecting conductive member, and an electrode connecting conductive member which is electrically connected to this cell assembly. Thus this technology is able to provide a fuel cell having stable power generating performance because the cell connecting conductive member which has a power collecting function is kept in contact with the electrode connecting conductive member. Also, Japanese Patent Application Publication No. JP-A-8-162142 describes technology relating to a solid-oxide fuel cell provided with a plurality of tube shaped fuel cell cells and a baffle plate. This technology is able to provide a solid-oxide fuel cell having improved power generating performance.

However, with the technology described in Japanese Patent Application Publication No. JP-A-2004-288542, power must first flow through the cell connecting conductive member and each tube shaped fuel cell cell before it can reach the electrode connecting conductive member. As a result, the connecting resistance is large which reduces the power collecting efficiency. With the technology described in Japanese Patent Application Publication No. JP-A-8-162142 as well, it is also difficult to improve the power collecting efficiency.

### SUMMARY OF THE INVENTION

This invention thus mainly aims to provide a tube shaped fuel cell module having excellent power collecting efficiency.

A first aspect of the invention thus relates to a tube shaped fuel cell module including a plurality of tube shaped fuel cell cells each of which has, in order from the inside, an internal collector, an inside catalyst electrode layer, a solid electrolyte membrane and an outside catalyst electrode layer; and an external collector which collects power from the tube shaped fuel cell cells, which is characterised in that the external collector has a corrugated plate structure in which convex portions and concave portions alternate repeatedly in one direction and which extends in a direction orthogonal to the one direction; and the tube shaped fuel cell module includes at least one cell-collector unit having the external collector, and the plurality of tube shaped fuel cell cells which contact the surface of the concave portions of the external collector along the entire lengths of the tube shaped fuel cell cells. With the external collector, a sectional shape of at least one of the concave portions and the convex portions in the one direction may be formed by a continuously smooth curved line. Also, a sectional shape of at least one of the concave portions and the convex portions in the one direction may be formed by a plurality of continuous segments having at least one bent portion.

According to this first aspect of the invention, the external collector has a corrugated plate structure so the external collector contacts the surface of the tube shaped fuel cell cells with an increased contact area, thus enabling a tube shaped fuel cell module having excellent collecting efficiency to be obtained. Also, in the first aspect of the invention, the tube shaped fuel cell cells contact the surface of the concave portions of the external collector over the entire lengths of the tube shaped fuel cell cells. Therefore, this tube shaped fuel cell module has greater collecting efficiency than a tube shaped fuel cell module in which only the end portions of the tube shaped fuel cell cells, for example, contact the external collector. Also, when the tube shaped fuel cell module is made by stacking together a plurality of the cell-collector units, pressure is normally applied in the direction in which the cell-collector units are stacked to increase the surface pressure between the external collector and the tube shaped fuel cell cells. Because external collector has a corrugated plate structure, it expands at this time in a direction orthogonal to the stacking direction, similar to a spring. In this way, the external collector flexibly deforms which enables uniform pressure to be applied to each of the tube shaped fuel cell cells, thereby improving collecting efficiency. Furthermore, when manufacturing the tube shaped fuel cell module according to this first aspect of the invention, the tube shaped fuel cell cells can be easily positioned if the external collector already has a corrugated plate structure.

In the first aspect described above, the cell-collector unit may be stacked in 2 to 24 layers, inclusive. This number enables more practical amounts of electric energy to be obtained. Any more layers may make it difficult to simplify the seal structure.

Also in the first aspect described above, the cell-collector unit may include a cooling pipe. Providing a cooling pipe makes it possible to suppress a decrease in performance of the fuel cell due to overheating.

Also in the first aspect described above, the cooling pipe may have one coolant supply port and one coolant discharge port per one cell-collector unit. Using a cooling pipe having this kind of structure simplifies the structure of a cooling pipe seal portion that fixes the cooling pipe.

Also in the first aspect described above, the cooling pipe may contact at least one of the tube shaped fuel cell cells of the cell-collector unit from one end portion to the other end portion of the tube shaped fuel cell cell. This structure enables the tube shaped fuel cell cell to be cooled more efficiently.

Also in the first aspect described above, at least one of a coolant supply direction and a coolant discharge direction of the cooling pipe may be a direction that differs from an axial direction of the tube shaped fuel cell cells when viewed from above. According to this structure, a seal portion that fixes the tube shaped fuel cell cells and the cooling pipe seal portion that fixes the cooling pipe are arranged in different positions, thereby preventing the seal structure from being multilayered and complex.

The first aspect of the invention thus enables a tube shaped fuel cell having excellent collecting efficiency to be obtained by using an external collector which has a corrugated plate shape.

A second aspect of the invention relates to a manufacturing method of a tube shaped fuel cell module including a plurality of tube shaped fuel cell cells each of which has, in order from the inside, an internal collector, an inside catalyst electrode layer, a solid electrolyte membrane and an outside catalyst electrode layer; and an external collector which collects power from the tube shaped fuel cell cells. This manufacturing method comprises the steps of forming a corrugated shape which includes concave portions and convex portions on the external collector, arranging the tube shaped fuel cell cells in the concave shapes of the external collector, making a cell-collector unit by arranging a cooling pipe on an intermediate body in which the tube shaped fuel cell cells are arranged in the concave shapes of the external collector, and making the tube shaped fuel cell module by stacking together a plurality of the cell-collector units.

The second aspect of the invention is thus able to realize a tube shaped fuel cell having excellent power collecting efficiency by using an external collector having a corrugated plate shape.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a perspective view of an external collector used in an example embodiment of the invention;

FIG. 2 is a perspective view of a cell-collector unit used in the example embodiment of the invention;

FIG. 3 is a perspective view of a tube shaped fuel cell module used in the example embodiment of the invention;

FIG. 4 is a sectional view schematically showing stacked cell-collector units;

FIG. 5 is a perspective view showing the arrangement of a cooling pipe;

FIG. 6 is a sectional view schematically showing the arrangement of the cooling pipe; and

FIG. 7 is a perspective view illustrating the direction in which coolant is supplied and the direction in which coolant is discharged.

### DETAILED DESCRIPTION OF THE PREFERRED EMBODIMENTS

Hereinafter, a tube shaped fuel cell module according to an example embodiment of the invention will be described in detail.

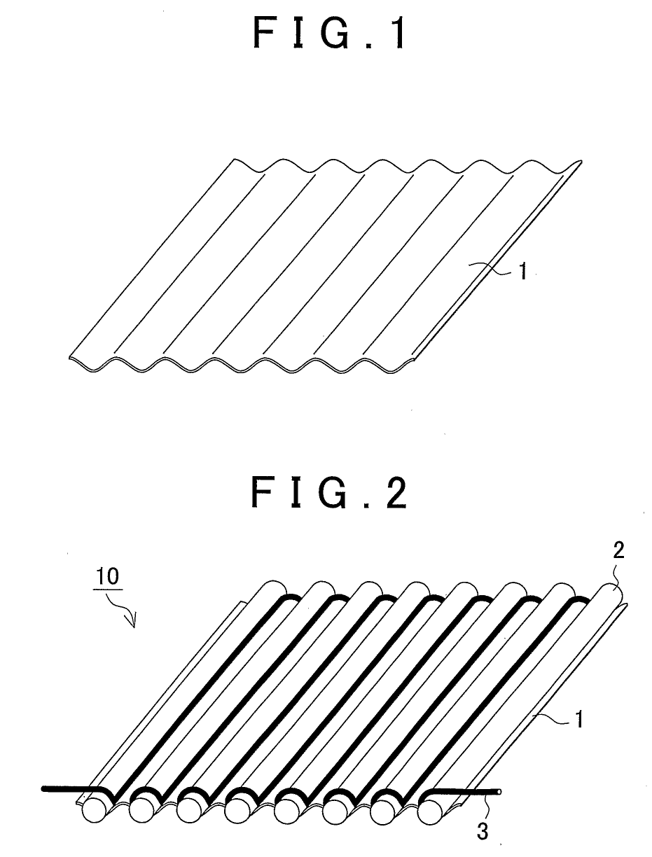

First, the various structures of the tube shaped fuel cell module according to this example embodiment will be described with reference to the drawings. FIG. 1 is a perspective view of an external collector used in this example embodiment. The external collector 1 has a corrugated structure of continuously alternating convex portions and concave portions. Because the external collector has this corrugated plate structure, the surfaces of the external collector and the tube shaped fuel cell cells contact one another with an increased contact area. This increased contact area thus makes it possible to obtain a tube shaped fuel cell module having excellent power collecting efficiency.

Also, FIG. 2 is a perspective view of a cell-collector unit used in this example embodiment of the invention. The cell-collector unit 10 includes the external collector 1 and a plurality of tube shaped fuel cell cells 2 which contact the concave portions of the surface of the external collector 1 along their entire lengths. This cell-collector unit 10 may include a cooling pipe 3, which makes it possible to suppress a decrease in performance of the fuel cell due to overheating. Although not shown, each of the tube shaped fuel cell cells 2 have, in order from the inside, an internal collector, an inside catalyst electrode layer, a solid electrolyte membrane and an outside catalyst electrode layer.

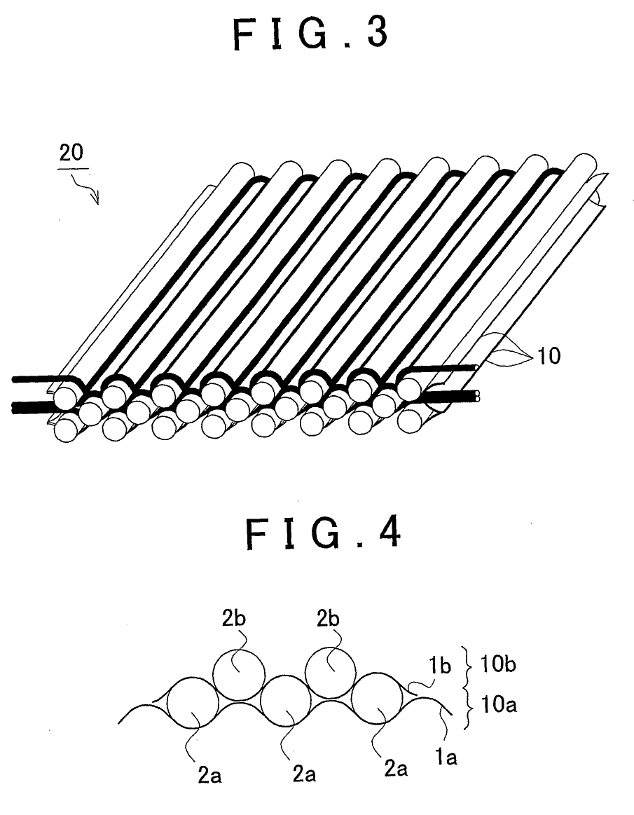

Also, FIG. 3 is a perspective view of a tube shaped fuel cell module used in this example embodiment of the invention. The tube shaped fuel cell module 20 shown in FIG. 3 has three layers of stacked cell-collector units 10. Although not shown in the drawing, an external collector having a corrugated plate shape is usually arranged on the surface of the uppermost cell-collector unit 10. Hereinafter, each structure of the tube shaped fuel cell module used in this example embodiment of the invention will be described in detail.

1. External Collector

First, the external collector used in this example embodiment of the invention will be described. The external collector serves to extract electric energy generated from tube shaped fuel cell cells which will be described later. This external collector has a corrugated plate structure of continuously alternating convex portions and concave portions. Moreover, the dimensions of the external collector are such that the tube shaped fuel cell cells contact the concave portions along substantially the entire length of the tube shaped cell cells. The phrase “substantially the entire length” in this case refers to between 80 to 100% of the lengths of the tube shaped fuel cell cells.

The dimensions of the convex portions and the concave portions of the external collector differ depending on the size and the like of the tube shaped fuel cell cells used, but are not particularly limited. In this example embodiment, when the plurality of the cell-collector units are stacked, as shown in FIG. 4, tube shaped fuel cell cells 2a of a cell-collector unit 10a contact the surface of an external collector lb of an adjacent cell-collector unit 10b. This structure increases the contact area between the tube shaped fuel cell cells and the external collector, thereby further improving collecting efficiency.

Also, the tube shaped fuel cell cells generate electric energy by supplying a reaction gas to the inside and outside of a hollow membrane electrode assembly (MEA), as described above. Therefore, the foregoing external collector which is arranged on the outside of the membrane electrode assembly normally has reaction gas passage holes. The external collector having these kinds of reaction gas passage holes is not particularly limited as long as it allows the reaction gas to contact the outside catalyst electrode layer. More specifically, the reaction gas passage holes of the external collector may be slit shaped or circular. An external collector having circular reaction gas passage holes can be obtained by machining so-called punch metal into a corrugated plate shape, for example.

The material of the external collector is also not particularly limited as long as it is conductive. This material may also be highly resistant to corrosion. More specifically, the material of the external collector may be, for example, a material plated with titanium or gold or platinum or tantalum, or a titanium clad material that has been coated with titanium or alloy of titanium, or a carbon coated material that has been coated with carbon, or the like.

Further, the thickness of the external collector may be within a range of 0.05 to 2 mm, inclusive, and more particularly, within a range of 0.1 to 0.3 mm, inclusive, for example, but is not particularly limited. If the external collector is too thin, the tube shaped fuel cell module may not have sufficient mechanical strength, and the internal resistance will increase. On the other hand, if the external collector is too thick, tube shaped fuel cell module will end up being larger.

2. Tube Shaped Fuel Cell Cell

The tube shaped fuel cell cells used in this example embodiment each have, in order from the inside, an internal collector, an inside catalyst electrode layer, a solid electrolyte membrane, and an outside catalyst electrode layer.

The internal collector is not particularly limited as long as it is conductive, allows reaction gas to pass through it in the axial direction of the tube shaped fuel cell cells, and allows reaction gas to contact the inside catalyst electrode layer. More specifically, the internal collector may be, for example, a cylindrical collector having a gas flow path groove formed in its surface, a collector into which a plurality of conductive wires are woven is straight lines, or the like.

Further, the inside catalyst electrode layer, the outside catalyst electrode layer, and the solid electrolyte membrane are also not particularly limited. The same members as those used in a typical tube shaped fuel cell may be used.

The outside diameters of the tube shaped fuel cell cells differ depending on, for example, the size and use of the tube shaped fuel cell module of this invention and may be in the range of 0.5 to 3 mm, inclusive, although they are not particularly limited. The lengths of the tube shaped fuel cell cells may be in the range of 30 to 600 mm, inclusive, although they too are not particularly limited. Also, when necessary, the tube shaped fuel cell cells may have a water repellent layer between the internal collector and the inside catalyst electrode layer and/or on the outside of the outside catalyst electrode layer, for example.

3. Cell-Collector Unit

The cell-collector unit includes the external collector and the plurality of tube shaped fuel cell cells that contact, along their entire lengths, the surface of the concave portions of the external collectors. In this example embodiment, the external collector has a corrugated plate structure so normally the tube shaped fuel cell cells are arranged in parallel along the concave portions of the external collector.

Also, in this example embodiment, the cell-collector unit may include a cooling pipe, which makes it possible to suppress a decrease in performance of the fuel cell due to overheating.

Moreover, in this example embodiment, each cell-collector unit in which the cooling pipe is provided has only one coolant supply port and one coolant discharge port. Using a cooling pipe having this kind of structure makes it possible to simplify the seal structure that fixes the cooling pipe. Also, when only one cooling pipe inlet and only one cooling pipe outlet are provided, the cooling pipe may either have a branching structure that extends from the inlet to the outlet or be a single pipe. The cooling pipe is easier to arrange, however, when it is a single pipe.

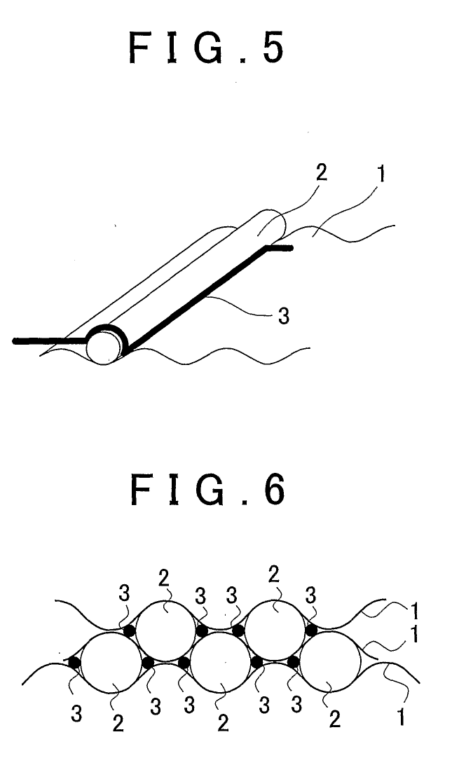

Also, the pattern in which the cooling pipe is arranged may be one with a large contact area between the cooling pipe and the tube shaped fuel cell cells, which would enable the tube shaped fuel cell cell to be cooled more efficiently, although it is not particularly limited. In this example embodiment, the cooling pipe may contact at least one of the tube shaped fuel cell cells of the cell-collector unit from one end portion to the other end portion. In FIG. 5, the cooling pipe 3 contacts the tube shaped fuel cell cells 2 from one end portion to the other end portion. The “end portion” in this case refers not only to strictly the end portions of the tube shaped fuel cell cells but to a portion that includes a adjacent region that extends toward the inside of the end portions. More specifically, the “end portion” refers to a portion extending from the ends of the tube shaped fuel cell cells to a point up to 10% of the lengths of the tube shaped fuel cells. Also, the cooling pipe may contact all of the tube shaped fuel cell cells of the cell-collector unit from one end portion to the other end portion. The cell-collector unit shown in FIG. 2 described above is an example of one such cell-collector unit.

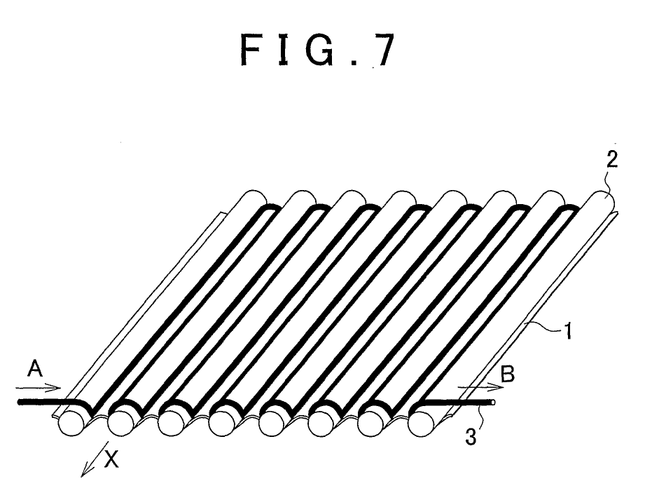

Also, the pattern in which the cooling pipe is arranged may be one which does not increase the thickness of the tube shaped fuel cell module when the cell-collector units are stacked to form the tube shaped fuel cell module. More specifically, the cooling pipe 3 is arranged in the gaps between the external collector 1 and the tube shaped fuel cell cells 2, as shown in FIG. 6. FIG. 6 is a schematic view of a cross-section of a portion of the tube shaped fuel cell module shown in FIG. 3, for example.

Also, in this example embodiment, at least one of the coolant supply direction of the cooling pipe and the coolant discharge direction of the cooling pipe is a direction which differs from the axial direction of the tube shaped fuel cell cells when viewed from above. The seal portion that fixes the tube shaped fuel cell cells and the cooling pipe seal portion that fixes the cooling pipe are arranged in different positions, thereby preventing the seal structure from being multilayered and complex. The coolant supply direction of the cooling pipe is the direction of the cooling pipe that connects a coolant supply source to the cell-collector unit and is just proximal to the cell-collector unit side. Also, the coolant discharge direction of the cooling pipe is the direction of the cooling pipe that connects the cell-collector unit to the coolant discharge point and is just proximal to the cell-collector unit side.

In this example embodiment, the coolant supply direction and the coolant discharge direction of the cooling pipe are both directions that differ from the axial direction of the tube shaped fuel cell cells when viewed from above. Also, the angle between the coolant supply direction and the axial direction of the tube shaped fuel cell cells may be a right angle but is not particularly limited. The same is true for the angle between the supply discharge direction and the axial direction of the tube shaped fuel cell cells.

FIG. 7 shows one specific example of a cell-collector unit having this kind of cooling pipe. In this example, both a coolant supply direction A and a coolant supply direction B of the cooling pipe 3 are directions which differ from the axial direction X of the tube shaped fuel cell cells 2 when viewed from above.

Also, the material of the cooling pipe may be highly resistant to corrosion but is not particularly limited. More specifically, a material plated with titanium or gold or platinum or tantalum, or a titanium clad material that has been coated with titanium or alloy of titanium, or a carbon coated material that has been coated with carbon, or the like may be used. The outside diameter of the cooling pipe differs depending on, for example, the size of the tube shaped fuel cell cells and may be in the range of 0.5 to 2 mm, inclusive, but is not particularly limited. Also, the coolant flowing through the cooling pipe may be water, for example.

4. Tube Shaped Fuel Cell Module

The tube shaped fuel cell module according to the invention includes at least one of the cell-collector units described above. The tube shaped fuel cell module in this example embodiment, however, includes a plurality of cell-collector units. In this example embodiment, the tube shaped fuel cell cells of one cell-collector unit contacts the surface of the external collector of another adjacent cell-collector unit, as described above with reference to FIG. 4. This structure increases the contact area between the tube shaped fuel cell cells and the external collector, thereby further improving collecting efficiency.

Moreover, the number of stacks of cell-collector units differs according to the use of the tube shaped fuel cell module and is not particularly limited. The tube shaped fuel cell module of this invention may have 2 to 24 layers of the stacked cell-collector units. This number enables more practical amounts of electric energy to be obtained. Any more than this may make it difficult to simplify the seal structure. More particularly, the tube shaped fuel cell module may have 3 and 6 layers, inclusive, which enables practical amounts of electric energy to be obtained while making it even easier to simplify the seal structure.

5. Manufacturing Method of the Tube Shaped Fuel Cell Module

The manufacturing method of the tube shaped fuel cell module of this example embodiment is not particularly limited as long as it enables the tube shaped fuel cell described above to be obtained. One method that can be used, for example, involves first making a cell-collector unit by preparing in advance an external collector having a corrugated plate structure, arranging tube shaped fuel cell cells in the concave portions of that external collector, and arranging a cooling pipe when necessary, then stacking together a plurality of these cell-collector units and applying pressure to them in the stacking direction.

While the invention has been described with reference to exemplary embodiments thereof, it is to be understood that the invention is not limited to the exemplary embodiments or constructions. To the contrary, the invention is intended to cover various modifications and equivalent arrangements. In addition, while the various elements of the exemplary embodiments are shown in various combinations and configurations, which are exemplary, other combinations and configurations, including more, less or only a single element, are also within the spirit and scope of the invention.

1-14. (canceled)

15. A tube shaped fuel cell module formed from at least one cell-collector unit, comprising:
a plurality of tube shaped fuel cell cells each of which has, in order from the inside, an internal collector, an inside catalyst electrode layer, a solid electrolyte membrane and an outside catalyst electrode layer; and
an external collector which collects power from the tube shaped fuel cell cells and has a corrugated plate structure in which convex portions and concave portions alternate repeatedly in one direction and which extends in a direction orthogonal to the one direction,
wherein the cell-collector unit includes the external collector, and the plurality of tube shaped fuel cell cells which contact the surface of the concave portions of the external collector along the entire lengths of the tube shaped fuel cell cells and wherein the cell-collector unit includes a cooling pipe.

16. The tube shaped fuel cell module according to claim 15, wherein
the external collector is made of a material plated with gold or platinum or tantalum or titanium or the like.

17. The tube shaped fuel cell module according to claim 15, wherein the external collector is made of a carbon coated material that has been coated with carbon, or a titanium clad material that is coated with titanium or alloy of titanium.

18. The tube shaped fuel cell module according to claim 15, wherein the cooling pipe has one coolant supply port and one coolant discharge port per one cell-collector unit.

19. The tube shaped fuel cell module according to claim 15, wherein the cooling pipe contacts at least one of the tube shaped fuel cell cells of the cell-collector unit from one end portion to the other end portion of the tube shaped fuel cell cell.

20. The tube shaped fuel cell module according to claim 15, wherein at least one of a coolant supply direction and a coolant discharge direction of the cooling pipe is a direction that differs from an axial direction of the tube shaped fuel cell cell when viewed from above.

21. The tube shaped fuel cell module according to claim 15, wherein the plurality of the cell-collector units are stacked,
the tube shaped fuel cell cells of one cell-collector unit contacts the surface of the external collector of another adjacent cell-collector unit, and
the cooling pipe is arranged in the gaps between the external collector and the tube shaped fuel cell cells.

22. A manufacturing method of a tube shaped fuel cell module including a plurality of tube shaped fuel cell cells each of which has, in order from the inside, an internal collector, an inside catalyst electrode layer, a solid electrolyte membrane and an outside catalyst electrode layer; and an external collector which collects power from the tube shaped fuel cell cells, comprising the steps of:
forming a corrugated shape which includes concave portions and convex portions on the external collector;
making a cell-collector unit by arranging the tube shaped fuel cell cells in the concave shapes of the external collector; and
making the tube shaped fuel cell module by stacking together a plurality of the cell-collector units; and
arranging a cooling pipe on the cell-collector unit in which the tube shaped fuel cell cells are arranged in the concave shapes of the external collector.
